(19) United States
(12) Patent Application Publication
(10) Pub. No.: US 2015/0205031 A1
(43) Pub. Date: Jul. 23, 2015

(54) ILLUMINATION DEVICE BASED ON LIGHT GUIDE WITH LIGHT SCATTERING PARTICLES AND LIGHT ANGLE SELECTION MODULE

(71) Applicant: KONINKLIJKE PHILIPS N.V., EINDHOVEN (NL)

(72) Inventors: Maartin Marinus Johannes Wilhelmus Van Herpen, Heesch (NL); TIM Dekker, Eindhoven (NL)

(73) Assignee: KONINKLIJKE PHILIPS N.V., EINDHOVEN (NL)

(21) Appl. No.: 14/423,341

(22) PCT Filed: Aug. 23, 2013
(86) PCT No.: PCT/IB2013/056833

§ 371 Date: Feb. 23, 2015

Related U.S. Application Data
(60) Provisional application No. 61/695,809, filed on Aug. 31, 2012.

(51) Int. Cl. F21V 8/00

(52) U.S. Cl. CPC G02B 6/0023; G02B 6/0041

(57) ABSTRACT

An illumination device (1) is disclosed comprising a light guide (2) with embedded light scattering and/or reflecting particles (5), a first light emitting element (6a), and a second light emitting element (6b). The illumination device (1) is arranged such that for light rays emitted by the first light emitting element (6a), the angles of incidence of the light rays coupled into the light guide (2) are within a first angle interval, and such that for light rays emitted by the second light emitting element (6b), the angles of incidence of the light rays coupled into the light guide (2) are within a second angle interval, wherein the first angle interval and the second angle interval are different. An illumination device (1) is provided in which the amount of light that is out-coupled from the light guide (2) at selected positions can be adapted as desired, for example to give uniform lighting.

### FIELD OF THE INVENTION

The present invention relates to an illumination device comprising a light guide with embedded light scattering and/or reflecting particles, a plurality of light emitting elements and a light angle selection module.

### BACKGROUND OF THE INVENTION

Illumination devices comprising a light source coupled with a light guide sheet or plate, which is able to propagate light internally, redirect and out-couple the light from its surface, provide for illuminating surfaces such as shelves, interior panels, signs and posters.

One light guide for use in such an illumination device is the ACRYLITE® EndLighten sheet from Evonik Industries. It comprises a sheet of a light conducting acrylic material in which light diffusing particles are embedded. The acrylic sheet accepts light from a light source through its end surfaces, from where the light propagates within the sheet by means of internal reflection. The light diffusing particles embedded in the sheet redirect the travelling light such that that at least some of it may exit the surface of the sheet, thereby giving the sheet its illuminating properties.

The brightness at each position of such a light guide is dependent on the distance that the light has to travel or propagate to arrive at the position, due to light losses in the light guide. This has the consequence that the edges of the light guide at which the light source or sources are positioned may be brighter than areas that are further away from the light source. Also, it has the consequence that light guides, for example of irregular or triangular shape, in which the light travels different distances, may be unevenly lighted.

### SUMMARY OF THE INVENTION

In view of the above discussion, a concern of the present invention is to provide an illumination device with a more uniform lighting, e.g. where the brightness of the light that is out-coupled from the light guide is more homogenous than the light out-coupled from the light guide described in the background section, or where the brightness of the light that is out-coupled from the light guide is even completely or nearly completely homogenous. Another related concern of the present invention is to provide an illumination device in which the amount of light that is out-coupled from the light guide at selected positions can be adapted as desired.

To address at least one of these concerns and other concerns, an illumination device in accordance with the independent claim is provided. Preferred embodiments are defined by the dependent claims.

According to a first aspect of the present invention, there is provided an illumination device comprising:

a light guide comprising embedded light scattering and/or reflecting particles and a light in-coupling surface adapted to couple light impinging on the light in-coupling surface into the light guide; and

a first light emitting element and at least a second light emitting element;

wherein at least some of the light emitted by the first light emitting element and the at least a second light emitting element respectively, impinges on the light in-coupling surface, wherein the illumination device is arranged such that for light rays emitted by the first light emitting element, the angles of incidence of the light rays impinging on the light in-coupling surface are within a first angle interval, and such that for light rays emitted by the at least a second light emitting element, the angles of incidence of the light rays impinging on the light in-coupling surface are within a second angle interval, wherein the first angle interval and the second angle interval are different, or substantially different.

For example, the illumination device may comprise a light angle selection module adapted to receive light emitted by the first light emitting element and the at least a second light emitting element, respectively, and output light such that at least some of the light emitted by the first light emitting element and the at least a second light emitting element respectively, impinges on the light in-coupling surface. The light angle selection module is arranged such that for light rays emitted by the first light emitting element, the angles of incidence of the light rays impinging on the light in-coupling surface are within the first angle interval, and such that for light rays emitted by the at least a second light emitting element, the angles of incidence of the light rays impinging on the light in-coupling surface are within the second angle interval.

Alternatively or optionally, light angle selection functionality as described above may be provided in the first light emitting element and in the at least a second light emitting element, respectively. In other words, the first light emitting element and the at least a second light emitting element, respectively, may be arranged such that at least some of the light emitted by the first light emitting element and the at least a second light emitting element respectively, impinges on the light in-coupling surface, and such that for light rays emitted by the first light emitting element, the angles of incidence of the light rays impinging on the light in-coupling surface are within the first angle interval, and such that for light rays emitted by the at least a second light emitting element, the angles of incidence of the light rays impinging on the light in-coupling surface are within the second angle interval, the first angle interval and the second angle interval being different, or substantially different.

In the following description, embodiments of the present invention are described with reference to the case where the illumination device comprises a light angle selection module as described in the foregoing. However, it is to be understood that all embodiments of the present invention described in the following apply correspondingly to the case where the light angle selection functionality in the illumination device as described above is provided in the first light emitting element and in the at least a second light emitting element, respectively, i.e. not by means of a separate light angle selection unit.

The term “angle of incidence”, as referred to herein, denotes the angle between a light ray incident on the light in-coupling surface and the line perpendicular to the light in-coupling surface at the point of incidence of the light ray, i.e. the surface normal of the light in-coupling surface at the point of incidence of the light ray.

In one embodiment, the light angle selection module is arranged such that for light rays emitted by the first light emitting element, the angles of incidence of the light rays impinging on the light in-coupling surface with respect to at least one plane are within a first angle interval, and such that for light rays emitted by the at least a second light emitting element, the angles of incidence of the light rays impinging on the light in-coupling surface with respect to the at least one plane are within a second angle interval, wherein one of the at least one plane is defined by the surface normal of said light in-coupling surface and a direction perpendicular to the surface normal of the light in-coupling surface. For example, the light to be in-coupled into the light guide may only be collimated in one direction.

The first angle interval and the second angle interval may for example be partly overlapping. For example, the first angle interval may be a sub-interval of the second angle interval, or vice versa. The angles within the first and or second angle intervals, respectively, have a maximum magnitude and a minimum magnitude corresponding to end points of the respective angle interval.

By the light rays emitted by the first light emitting element and the light rays emitted by the at least a second light emitting element, respectively, being incident on the light in-coupling surface of the light guide within different intervals of angles of incidence, the rate of light that is subsequently coupled out from the light guide is different with respect to light from the respective ones of the first and the at least a second light emitting elements. The smaller the average magnitude of angle of incidence of the light rays within a light beam, the slower is the light subsequently coupled out of the light guide. This will be described in more detail below.

By appropriate selection of the interval of angles of incidence of the light beams from the first light emitting element and the at least a second light emitting element across the light in-coupling surface of the light guide, out-coupling of light from the light guide, for example to achieve a desired spatial uniformity of the out-coupled light across a light out-coupling surface of the light guide, may be facilitated or enabled.

In order to achieve uniform lighting output from the light guide, e.g. via a light out-coupling surface of the light guide, the rate at which the light is out-coupled from the light guide is of relevance. The rate at which the light is out-coupled from the light guide is dependent on the distance that the light has to travel or propagate within the light guide. For instance, at a position in the light guide for which the in-coupled light has to travel through the light guide a relatively long distance in order to reach the position, the light should be out-coupled at a slow rate in order to achieve a uniform light output from the light guide. And likewise, at a position in the light guide for which the in-coupled light has to travel a relatively short distance in order to reach the position, the light should be out-coupled at a higher rate in order to achieve a uniform light output from the light guide. The present invention facilitates or enables means for adaptation of the rate and extent by which the in-coupled light is out-coupled from the light guide, by appropriate selection of the interval of angles of incidence of the light beams from the first light emitting element and the at least a second light emitting element across the light in-coupling surface of the light guide. The present invention facilitates or enables out-coupling light from the light guide at different rates and extents depending on the point of out-coupling.

Moreover, by appropriate selection of the interval of angles of incidence of the light beams from the first light emitting element and the at least a second light emitting element across the light in-coupling surface of the light guide, it is possible to increase the intensity of the light coupled into the light guide while keeping the uniformity of the light output from the light guide similar or even the same.

The illumination device according to the present invention comprises a light guide with embedded light scattering and/or reflecting particles, elements and/or structures. The light guide is arranged to enable propagation of light coupled into it by means of total internal reflection (TIR). The light guide comprises a material through which light can propagate. The material is preferably a transparent material. The term “transparency”, as referred to herein, is the physical property of allowing light to pass through the material in which the light scattering and/or reflecting particles are embedded without being scattered. In different embodiments, the light guide comprises a material selected from poly(methylmethacrylate) (PMMA), polycarbonate, glass and/or silicon rubber. PMMA is sometimes called acrylic glass. A light guide may comprise more than one of these materials. For example, the light guide may comprise PMMA, polycarbonate, glass and/or silicon rubber.

The light guide may have various forms, such as a plate, a rod or a fiber. The shapes of the light guide may be substantially regular or irregular. At least a portion of the outer surface of the light guide may be smooth. In other example, at least a portion of the outer surface of the light guide is rough, i.e. not smooth. However, arranging the outer surface of the light guide such that at least a portion thereof is rough is in general only desired in case an increased light output from the light guide is required. By arranging selected portions of the outer surface of the light guide to be rough, an increased uniformity in light output from the light guide may be achieved. The light guide may have a rectangular, triangular or circular shape.

The light guide comprises light scattering and/or reflecting particles embedded into the material.

The light emitting elements may in principle comprise any kind of element that is able to generate and emit light. For example, the light emitting elements may comprise light emitting diodes, LEDs. RGB LEDs are advantageously used to enable dynamic color light output from the illumination device. A plurality, i.e. two or more, of light emitting elements in the illumination device may be of the same type or different types.

The light emitting elements emit light during use. The light guide accepts light from at least two light emitting elements through at least one light in-coupling surface, from which the light propagates within the light guide by means of total internal reflection. The light scattering and/or reflecting particles embedded in the light guide redirect the light propagating within the light guide such that at least some of it may exit a surface, e.g. light out-coupling surface, of the light guide unit, thereby giving the light guide unit at least some of its illuminating properties.

The light angle selection unit may be arranged to provide the difference in intervals of angles of incidence of light from the first light emitting element and the at least a second light emitting element in-coupled into the light in-coupling surface of the light guide in a number of different ways. For example, the light rays of the emitted light from the light emitting elements may be redirected to become more parallel with respect to the surface normal of the light in-coupling surface of the light guide, i.e. through collimation. Optionally or alternatively, light rays having certain angles of incidence may be blocked or prevented from entering the light guide.

In one embodiment the light angle selection unit is arranged such that a maximum magnitude of an angle with respect to angles in the first angle interval is larger than a maximum magnitude of an angle with respect to angles in the second angle interval, or vice versa. This may for instance be achieved by collimating the light emitted from the first light emitting element and light emitted from the second light emitting element to different degrees.

Accordingly, in one embodiment the light angle selection module comprises at least one collimator adapted to collimate light received from the first light emitting element and/or from the at least a second light emitting element, respectively, such that light from the first light emitting element impinging on the light in-coupling surface, and light from the at least a second light emitting element impinging on the light in-coupling surface, have different degrees of collimation.

By collimating the light, a larger proportion of the light rays within the light beam impinging on the light in-coupling surface of the light guide have a smaller angle of incidence. In other words, the average magnitude of the angles of the light rays in the light beam, with respect to the surface normal of the light in-coupling surface of the light guide, is reduced. The higher the degree of collimation, the smaller is the average magnitude of the angle of the light rays in the light beam with respect to the surface normal of the light in-coupling surface of the light guide, and accordingly the slower will the light be out-coupled from the light guide. In this context, by ‘slow’ out-coupling of light from the light guide, it is meant that the amount of light that is coupled out from the light guide as a function of distance within the light guide from the location of light in-coupling, e.g. from the light in-coupling surface, is relatively small. Due to such slow out-coupling of light from the light guide, light within the light guide can travel relatively far in the light guide because light is not out-coupled or leaking out from the light guide quickly after having been coupled into the light guide.

The collimator may collimate the light received from one of the light emitting elements only, or may alternatively collimate the light received from both light emitting elements to different extents.

In one embodiment the at least one collimator comprises at least two collimator units, wherein a first collimator unit is adapted to collimate received light from the first light emitting element and a second collimator unit is adapted to collimate received light from the at least a second light emitting element. The first and second collimator units are further arranged such that light from the first light emitting element impinging on the light in-coupling surface and light from the at least a second light emitting element impinging on the light in-coupling surface have different degrees of collimation.

In another embodiment the at least one collimator is adapted to vary the degree of collimation of light received by the at least one collimator such that the degree of collimation of light impinging on the light in-coupling surface varies with respect to the position of incidence of the light on the at least one collimator and as a result varies with respect to the position of incidence of the light on the in-coupling surface. In such an embodiment a single collimator providing a transition in the degree of collimation may be used to collimate light from more than one light emitting element.

At least one of the collimator and collimators units may comprise a flat collimator. Examples of flat collimators include the flat collimating LED waveguides described in patent documents US2011096570 A1, US2011085332 A1 and US2011063855 A1. Such flat collimators comprise substantially flat waveguides that are arranged to collimate light. They may for instance be arranged to collimate light in a first direction by use of reflective surfaces having a collimating angle, and to collimate light in a second direction, which is perpendicular to the first direction, by use of grooved surfaces that are substantially perpendicular to the reflective surfaces. The illumination device according to the present invention may comprise two or more such flat collimators that output light that is collimated to different degrees, for example by having differently angled reflective surfaces and/or by having grooved surfaced comprising differently arranged grooves. An advantage with using flat collimators is that the light guide and the collimators may all be arranged to be substantially flat, and may further be arranged to have the same thickness. This may facilitate manufacture of the illumination device, improve its functionality by providing more efficient in-coupling of light into the light guide, and provide a more aesthetic appearance of the illumination device.

Collimation may alternatively or optionally by achieved by other means and/or methods known in the art. Examples of collimation devices and methods include collimating reflectors and refractors, for example lenses, and diffractive methods such as use of Fresnel lenses.

In one embodiment the light angle selection module is arranged such that a minimal magnitude of an angle with respect to angles in the first angle interval is larger than a minimal magnitude of an angle with respect to angles in the second angle interval, or vice versa. This may for instance be achieved by preventing light rays of within a certain interval of angles of incidence to be coupled into the light guide. The prevention of light rays to be coupled into the light guide may for instance be achieved by blocking the light beam from one of the light emitting elements with a light blocker such as an optical block.

Accordingly, the angle selection module may comprise at least one light blocker adapted to block light rays, received from the first light emitting element and/or the at least a second light emitting element, having angles of incidence within at least one selected angle interval.

In one example the light blocker prevents light rays having a small angle of incidence from being coupled into the light guide. Thus, only light rays with a large angle of incidence are able to pass the light blocker and be coupled into the light guide. Since the resulting input light beam comprises a large proportion of light rays with a large angle of incidence, it may only propagate a short distance into the light guide, or travel a short distance within the light guide, and be out-coupled from the light guide relatively fast. Since the light travel within the light guide by means of total internal reflection (TIR), the distance the light has propagated in the light guide, i.e. the distance from the point or position of in-coupling of the light to the position or location where the light is out-coupled from the light guide, may be relatively small compared to the total distance the light travels within the light guide before being out-coupled from the light guide. Such a light blocker, blocking light rays with small angles of incidence, is thus suitable for achieving light that is desired not to propagate far into the light guide. In an alternative example a light blocker that prevents light rays within an interval of large angles of incidence from being coupled into the light guide, is used. Such a light blocker, blocking light rays with large angles, is suitable for arranging light that is desired to propagate far into the light guide.

The light blocker may either block the light received form one of the light emitting elements only, or may alternatively block the light received from both light emitting elements to different extents.

In one embodiment light blocker comprises at least two light blocking units wherein a first light blocking unit is adapted to block light rays within a first selected interval of angles of incidence and is arranged to block light received light from the first light emitting element, and wherein a second light blocking unit is adapted to block light rays within a second selected interval of angles of incidence and is arranged to block light received light from the second light emitting element. The light blocking units are further arranged such that light rays from the first light emitting element impinging on the light in-coupling surface and light rays from the at least a second light emitting element impinging on the light in-coupling surface are within different interval of angles of incidence.

In another embodiment the at least one light blocker is adapted to vary the interval of angles of incidence that is blocked by the at least one light blocker, such that the interval of angles of incidence of the light rays impinging on the light in-coupling surface varies with respect to the position of incidence of the light on the in-coupling surface. In such an embodiment a single light blocker providing a transition in the angle interval of light rays that are blocked may be used to block light from more than one light emitting element.

The light from the two or more light emitting elements of the illumination device may in alternative embodiments be arranged to have different intervals of angles of incidence by use of different methods. For example, the light beam emitted from a first light emitting element of the illumination device may be collimated by a collimator, while the light beam emitted from a second emitting element of the same illumination device may be filtered from light rays of certain angles by use of a light blocker.

An illumination device according to the present invention may be used for illuminating surfaces such as shelves, interior panels, thin profile signs and poster panels, etc. The illumination device is may advantageously be comprised in a luminaire, such as a consumer luminaire used for general lighting of a space, such as a home.

According to a second aspect of the present invention, there is provided a luminaire comprising an illumination device according to the present invention.

Further objects and advantages of the present invention are described in the following by means of exemplifying embodiments.

It is noted that the present invention relates to all possible combinations of features recited in the claims. Further features of, and advantages with, the present invention will become apparent when studying the appended claims and the following description. Those skilled in the art realize that different features of the present invention can be combined to create embodiments other than those described in the following.

### BRIEF DESCRIPTION OF THE DRAWINGS

Exemplifying embodiments of the invention will be described below with reference to the accompanying drawings, wherein:

FIGS. 1a and 1b schematically depict an illumination device according to an embodiment of the present invention.

FIG. 2 schematically depicts a working principle of the present invention.

FIGS. 3a and 3b schematically depict embodiments of an illumination device according to the present invention, comprising at least one collimator.

FIG. 4 schematically depicts a side-view of an illumination device according to an embodiment of the present invention, comprising an optical block.

FIG. 5 schematically depicts an embodiment of an illumination device according to an embodiment of the present invention, comprising optical blocks.

As illustrated in the figures, the sizes of different elements are exaggerated for illustrative purposes and, thus, are provided to illustrate the general structures of embodiments of the present invention.

### DETAILED DESCRIPTION OF THE EMBODIMENTS

The present invention will now be described more fully hereinafter with reference to the accompanying drawings, in which exemplifying embodiments of the present invention are shown. The present invention may, however, be embodied in many different forms and should not be construed as limited to the embodiments set forth herein; rather, these embodiments are provided by way of example so that this disclosure will convey the scope of the invention to those skilled in the art. Furthermore, like numbers refer to the same or similar elements or components throughout.

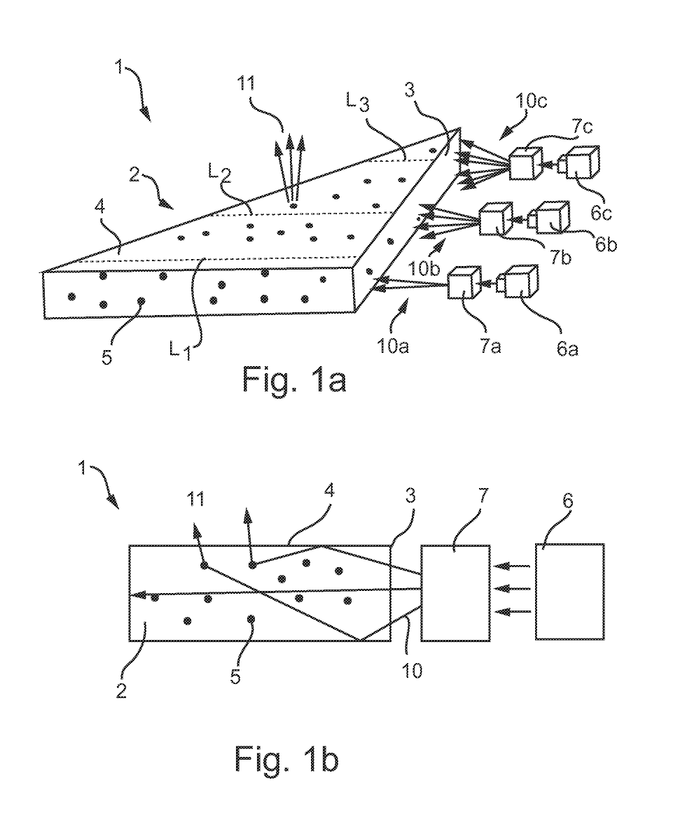

FIG. 1a schematically depicts an illumination device 1, arranged to generate output light 11. The illumination device 1 comprises a plurality of light emitting elements 6a, 6b, 6c, a plurality of light angle selection modules 7a, 7b, 7c and a light guide 2. The light angle selection modules 7a, 7b, 7c are arranged to couple input light beams 10a, 10b, 10c from the light emitting elements 6a, 6b, 6c into the light guide 2. The light guide 2 is arranged to receive the input light beams 10a, 10b, 10c and to out-couple it as output light 11. The interval of angles of incidence of the input light beams 10a, 10b, 10c is arranged by the light angle selection modules 7a, 7b, 7c to be different for the light from the respective light emitting elements 6a, 6b, 6c, as it is coupled into the light guide 2. The angle of incidence denotes the angle between a light ray incident on the light in-coupling surface 3 and the line perpendicular to the light in-coupling surface 3 at the point of incidence of the light ray, i.e. the surface normal of the light in-coupling surface 3 at the point of incidence of the light ray. In the example shown, the maximum magnitude of the incidence angles of the input light beam 10a from a first light emitting element 6a is smaller than the maximum magnitude of the incidence angles of the input light beams 10b, 10c from the second and third light emitting elements 10b, 10c. In other words, the average magnitude of the angles of incidence of the light rays within each input light beam 10a, 10b, 10c is arranged to be different.

FIG. 1b schematically depict the illumination device 1 shown in FIG. 1a from a side view different from the view in FIG. 1a, where the light emitting elements are indicated by reference numeral 6 and the light angle selection modules are indicated by reference numeral 7.

The light emitting elements 6, 6a, 6b, 6c may in principle comprise any kind of element that is able to generate and emit light. For example, the light emitting elements 6, 6a, 6b, 6c may comprise light emitting diodes, LEDs. RGB LEDs are advantageously used to enable dynamic color light output from the illumination device 1. The plurality, i.e. two or more, of light emitting elements 6, 6a, 6b, 6c within an illumination device 1 according to the present invention may be of the same type or different types.

In FIGS. 1a and 1b the light guide 2 comprises a waveguide which is arranged to receive input light 10 through or via a light in-coupling surface 3 and to out-couple the light through or via a light out-coupling surface 4. In a preferred embodiment, as shown in FIGS. 1a and 1b, the light guide 2 is substantially plate shaped, having edge surfaces along its edges, as well as a top surface and a bottom surface. The top and bottom surfaces are parallel. A light in-coupling surface 3 is arranged on at least one of the edge surfaces and is perpendicular to the top and bottom surfaces. The light out-coupling surface 4 is arranged on the top and bottom surfaces. The light guide 2 may alternatively be arranged in various other ways. For example it may have a curved configuration, having curved top and bottom surfaces, have a more rod-like shape, be triangular, circular or have any other regular or irregular shape. In alternative, a light out-coupling surface 4 may be arranged on either the top or the bottom surface.

The light guide 2 is arranged to enable propagation of light coupled into it by means of total internal reflection (TIR). It comprises a material through which light can propagate. The material is preferably a transparent material. Examples of such materials include transparent acrylic materials such as poly(methylmethacrylate) (PMMA), polycarbonate, glass and silicon rubber.

Light scattering and/or reflecting particles 5 are embedded in the wave guide. These particles 5 enable out-coupling of the light as output light 8. The light scattering and/or reflecting particles 5 redirect light beams that impinge upon them, and may redirect at least some of the light beams towards the light out-coupling surface 4, at an angle of incidence that is smaller than the critical angle for TIR, thus enabling the light beam to be out-coupled from the light out-coupling surface 4 of the light guide unit 2.

The light angle selection modules 7a, 7b, 7c are adapted to receive light emitted by the light emitting elements 6a, 6b, 6c. They are also arranged to output light such that at least some of the output light is coupled into the light in-coupling surface 3 of the light guide 2.

The light angle selection modules 7a, 7b, 7c are further arranged to select or adapt the light rays of the light emitted from the light emitting elements 6a, 6b, 6c such that only light rays within a certain interval of angles of incidence are coupled into the light guide 2.

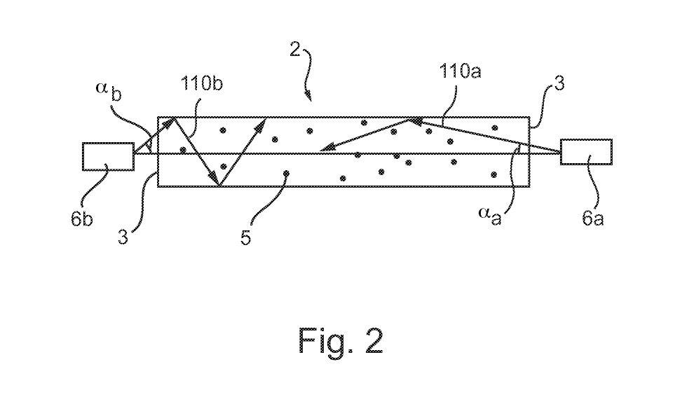

The variation in interval of angles of incidence of the different input light beams 10a, 10b, 10c enables adjustment of how the light is coupled out from the light guide 2. The principle for this is shown schematically in FIG. 2. The figure shows two examples of light rays 110a, 110b, originating from light sources 6a, 6b. Since light in-coupling surface 3 is substantially flat the surface normal in each point of the in-coupling surface is approximately the same. An example of a surface normal of the light in-coupling surfaces 3 is shown as a dotted line. Light ray 110a is in-coupled into the light guide 2 at a small angle αₐ in relation to the surface normal, i.e. at a small angle of incidence. Light ray 110b is in-coupled into the light guide 2 at a larger angle of incidence α_{b}. Light rays 110a and 110b travel within the light guide 2 by means of total internal reflection (TIR). In the scenario depicted in FIG. 2, the total distance that both rays 110a, 110b have traveled within the light guide 2 is substantially the same. However, light ray 110a has propagated much further into the light guide 2 than light ray 110b. Light ray 110b, with a larger angle of incidence α_{b} than the angle of incidence αₐ of light ray 110a, makes more reflections within the light guide 2, and therefore does not propagate as far into the light guide 2 as light ray 110a although the light rays 110a and 110b in the scenario depicted in FIG. 2 have traveled substantially the same distance within the light guide 2.

The amount of light that is coupled out of the light guide 2 is a function of the distance of travel or propagation through the light guide 2. Therefore, light ray 110b, with a larger angle of incidence α_{b}, will be coupled out of the light guide 2 faster than light rays 110a with a smaller angle of incidence αₐ. Light rays 110a with a smaller angle of incidence αₐ will be coupled out more slowly, and will thus be able to propagate further into the light guide 2 before being coupled out. Accordingly, light beams having a high proportion of light rays with a large angle of incidence α will be coupled out of the light guide 2 faster than light beams having a high proportion of light rays with a smaller angle of incidence α.

One way of adjusting the interval of angles of incidence of a light beam is by use of collimation. In FIG. 1a the input light beam 10a emitted from light emitting element 6a is collimated to a higher degree than the input light beam 10c emitted from light emitting element 6c. The more collimated the light is, the larger is its proportion of light rays having small angles of incidence α. Accordingly, more collimated light will to a higher degree propagate further into the light guide than less collimated light. As exemplified in FIG. 1a, the input light beam 10a emitted from light emitting element 6a will thus propagate further into the light guide 2 than input light beam 10c emitted from light emitting element 6c. The input light 10a will also be out-coupled from the light guide 2 more slowly than input light 10b, and thus less intensely. In order to compensate for this, the intensity of the more collimated light beam 10a can be increased. Collimation of the light also allows for increasing the intensity of the input light beam 10 with a reduced risk of having bright light spots appear at the light in-coupling edge of the light guide.

By varying the collimation of the input light beam 10 one can thus adjust the distance that the light travels through the light guide 2 from the light in-coupling surface 3, before being out-coupled. In other words, the degree of collimation can be used for varying the distance that the light propagates within the light guide plate 2. The more collimated the light is, the further will it travel through the light guide 2, and the slower will it be out-coupled from the light out-coupling surface 4. In other words, the more collimated the light is, the further the light will travel within the light guide 2, and the lower the light out-coupling efficiency. This can for example be used for achieving uniform lighting output from a light guide 2 having a shape in which the travel or propagation distance for the light, from the light in-coupling surface 3, varies. FIG. 1a shows such an illumination device 1 with a light guide 2 that is triangular. The distance, as schematically illustrated by L₁ in FIG. 1a, that the light has to travel through the light guide 2, in order to be out-coupled across substantially the full length of the light guide 2, is longer for the input light beam 10a emitted from light emitting element 6a at the base of the triangle, than for the input light beams 10b and 10c, emitted from light emitting elements 6b and 6c, at the middle and top of the triangle respectively. By arranging the input light beam 10a to be most collimated, input light beam 10b to be less collimated and input light beam 10c to be least collimated, light at the longest side of the triangle (indicated by L₁) will travel further into the light guide 2 than light at the middle (indicated by L₂) and at the top (indicated by L₃) of the triangle. The light will be evenly output across the length L at all three positions of the triangle, including at the long base, owing to the collimation. Thereby uniform output light 11 is achieved. The lower degree of light out-coupling for more collimated light can be compensated for by increasing the intensity of the more collimated input light beam 10 by a corresponding magnitude. Thus, by further arranging the input light beam 10a to be most intense, the input light beam 10b to be less intense and input light beam 10c to be least intense, the output light 11 may be even more uniform.

The skilled person realizes that uniform output lighting of a triangular or otherwise irregularly shape light guide 2 can be correspondingly arranged by use of other types of light selections modules 8, such as the light blocking units 8 disclosed hereinafter.

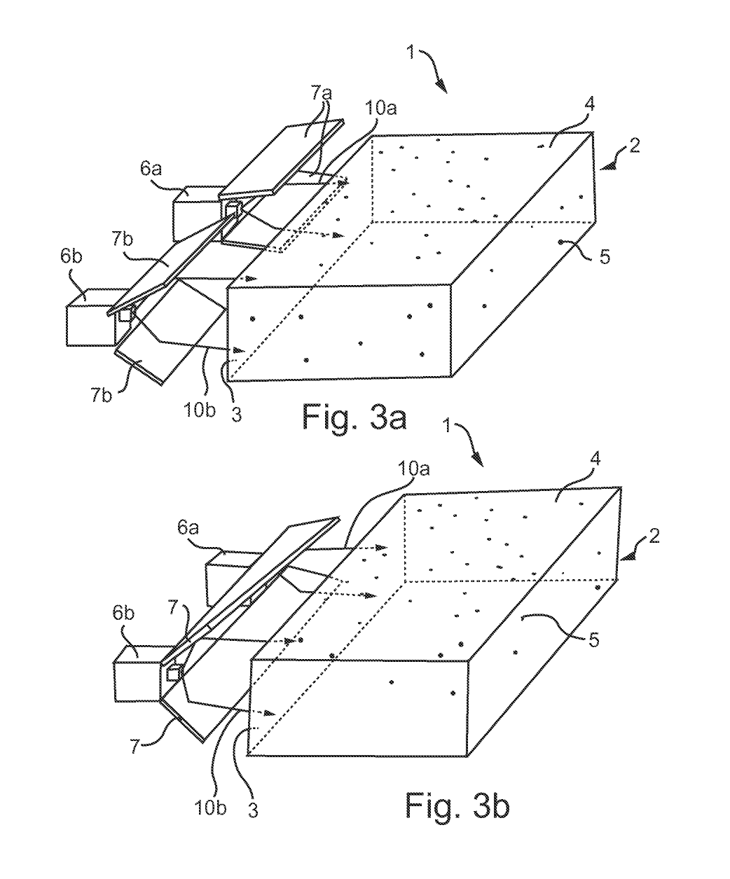

FIG. 3a shows a schematic embodiment of an illumination device 1 according to the present invention, which comprises two light emitting elements 6a, 6b and a light guide 2. The light guide 2 comprises light scattering and/or reflecting particles 5 and is arranged to receive input light 10 form the light emitting elements 6a, 6b through or via a light in-coupling surface 3. The illumination device 1 further comprises two collimators 7a, 7b that are arranged to collimate the light beams 10a, 10b from the respective light emitting elements 6a, 6b before the light is coupled into the light guide 2 via the light in-coupling surface 3. The collimators 7a, 7b reflect the light from the light emitting elements 6a, 6b such that they become more parallel to the surface normal of the light in-coupling surface 3, i.e. such that they become more collimated in a direction that is substantially perpendicular to the surface normal of the light in-coupling surface 3. Thereby the average angle of incidence α of their light rays is reduced. Collimator 7a is arranged to collimate light to a higher degree than collimator 7b, by redirecting the light towards the surface normal to a greater extent.

FIG. 3b shows a similar embodiment, wherein a single collimator 7 is used to provide different collimation of the light emitted from light emitting elements 6a, 6b. The single collimator 7 redirects the input light beams 10a, 10b from the two light emitting elements 6a,6b differently, via a smooth transition in the angle of redirection. Thereby a smooth transition in the degree of collimation is achieved when going from input light beam 10b emitted by light emitting element 6b to input light beam 10a emitted by light emitting element 6a.

It is to be understood that a larger number of light emitting elements 6 and/or collimators 7 than shown in FIGS. 3a and 3b may be used in an illumination device 1 according to the present invention. Further, it is to be understood that the degree of collimation need not gradually increase or decrease along the light in-coupling surface 3 of the light guide 2. When the light guide 2 has an irregular shape, or if there is another reason for desiring different light out-put along the light guide 2, one or more collimators 7 providing different degrees of collimation may be arranged along the light guide 2 accordingly. This also applies to embodiments wherein the different degrees of collimation is achieved by means of other collimation adjusting elements than collimators, such as reflectors, refractors, optical blocks or diffracting methods such as Fresnel lenses.

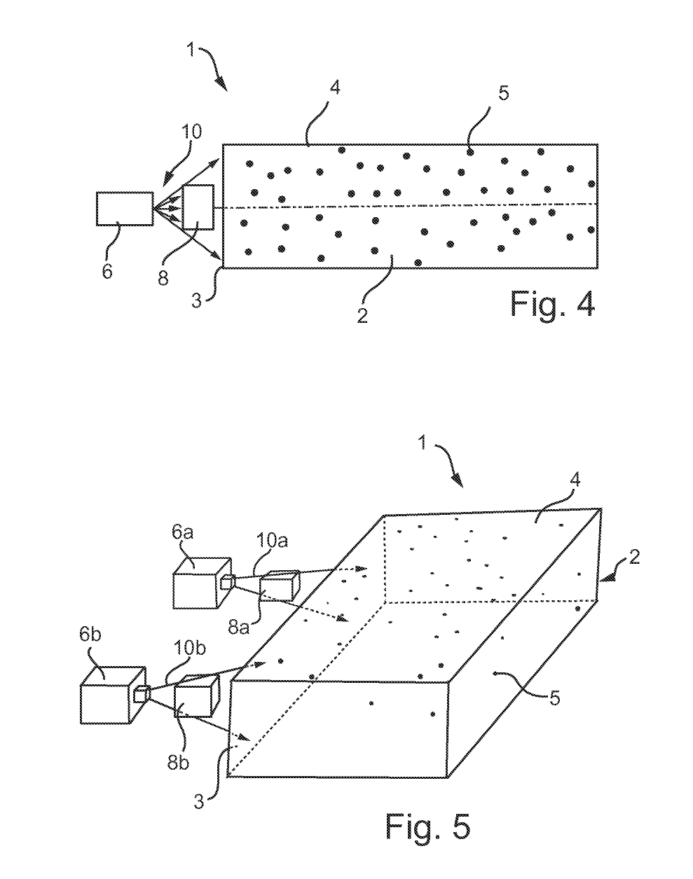

The variation in interval of angle of incidence for the input light beams 10 from the different light emitting elements 6 may in an alternative embodiment be achieved by preventing light traveling at certain angles of incidence α from being coupled into the light guide, for example by use of a light blocker such as an optical block. FIG. 4 shows an example, where a light angle selection module in form of a light blocking unit 8 is placed in front of the light emitting element 6. The light blocking unit 8 prevents light rays within a interval of small angles of incidence α from being coupled into the light guide. Only light rays with a large angle of incidence α can pass the light blocking unit 8 and thus be coupled into the light guide 2. Since the resulting input light beam 10 comprises a large proportion of light rays with a large angle of incidence α it will propagate a short distance into the light guide 2. Such a light blocking unit 8 is thus suitable for providing light with a lower degree of collimation, for light that is desired not to propagate far into the light guide 2.

In order to achieve different intervals of angles of incidence for the light emitted from two or more light emitting elements 6, one light blocking unit 8 may be used such that light from one of the light emitting elements 6, but not the other, is blocked. As shown in FIG. 5 two or more light blocking units 8, or one light blocking unit for each light emitting element, may be alternatively be used. The optical blocks 8 are then arranged such that the respective light blocking units 8 block light rays of a different interval of angles of incidence α, for example by being of different sizes. In another embodiment, a single light blocking unit 8 may be used to block the light from the different light emitting elements 6 differently. Such a single light blocking unit 8 may be arranged to provide a transitional degree of blocking, for example by having a smooth size transition, such that light rays of an interval of larger angles of incidence are blocked at a first end of the light blocking unit 8 and an interval of smaller angles of incidence are blocked at a second end of the light blocking unit 8.

In conclusion, an illumination device is disclosed, comprising a light guide with embedded light scattering and/or reflecting particles, a first light emitting element, and a second light emitting element. The illumination device is arranged such that for light rays emitted by the first light emitting element, the angles of incidence of the light rays coupled into the light guide are within a first angle interval, and such that for light rays emitted by the second light emitting element, the angles of incidence of the light rays coupled into the light guide are within a second angle interval, wherein the first angle interval and the second angle interval are different. An illumination device is provided in which the amount of light that is out-coupled from the light guide at selected positions can be adapted as desired, for example to give uniform lighting.

While the present invention has been illustrated and described in detail in the appended drawings and the foregoing description, such illustration and description are to be considered illustrative or exemplifying and not restrictive; the present invention is not limited to the disclosed embodiments. Other variations to the disclosed embodiments can be understood and effected by those skilled in the art in practicing the claimed invention, from a study of the drawings, the disclosure, and the appended claims. The mere fact that certain measures are recited in mutually different dependent claims does not indicate that a combination of these measures cannot be used to advantage. Any reference signs in the claims should not be construed as limiting the scope.

1. An illumination device (1) comprising:
a light guide plate that is arranged to enable propagation of light coupled into it by means of total internal reflection, the light guide plate having a light in-coupling surface arranged on an edge surface and a light-outcoupling surface arranged on at least one of a bottom surface and a top surface, the light in-coupling surface being adapted to couple light impinging on the light in-coupling surface into the light guide plate, the light guide plate further comprising embedded light scattering and/or light reflecting particles,
a first light emitting element,
a second light emitting element, and
a light angle selection module adapted to receive light emitted by the first light emitting element and the second light emitting element, respectively, and to output light such that
at least some of the light emitted by the first light emitting element and the second light emitting element, respectively, impinges on the light in-coupling surface,
wherein the light angle selection module is arranged such that for light rays emitted by the first light emitting element the angles of incidence of the light rays impinging on the light in-coupling surface are within a first angle interval with respect to a plane,
wherein the light angle selection module is arranged such that for light rays emitted by the second light emitting element the angles of incidence of the light rays impinging on the light in-coupling surface are within a second angle interval with respect to the plane,
wherein the first angle interval and the second angle interval are different, and
wherein the plane is defined by the surface normal of the light in-coupling surface and the surface normal of the light out-coupling surface.

2. (canceled)

3. (canceled)

4. The illumination device according to claim 1, wherein the light angle selection module is arranged such that a maximum magnitude of an angle with respect to angles in the first angle interval is larger than a maximum magnitude of an angle with respect to angles in the second angle interval, or vice versa.

5. The illumination device according to claim 1, wherein the light angle selection module comprises a collimator adapted to collimate light received from the first light emitting element and/or the second light emitting element, respectively, such that light from the first light emitting element impinging on the light in-coupling surface, and light from the second light emitting element impinging on the light in-coupling surface, have different degrees of collimation.

6. The illumination device according to claim 5, wherein the collimator comprises at least two collimator units, wherein a first collimator unit is adapted to collimate received light from the first light emitting element and wherein a second collimator unit is adapted to collimate received light from the second light emitting element.

7. The illumination device according to claim 5, wherein the collimator is adapted to vary the degree of collimation of light received by the collimator such that the degree of collimation of light impinging on the light in-coupling surface varies with respect to the position of incidence of the light on the in-coupling surface.

8. The illumination device according to claim 5, wherein at least one of the collimator and collimator units comprises a flat collimator.

9. The illumination device according to claim 5, wherein at least one of the collimator and collimator units is selected from the group consisting of collimating reflectors, refractors and diffractive devices.

10. The illumination device according to claim 1, wherein the light angle selection module is arranged such that a minimum magnitude of an angle with respect to angles in the first angle interval is larger than a minimum magnitude of an angle with respect to angles in the second angle interval, or vice versa.

11. The illumination device according to claim 1, wherein the light angle selection module comprises a light blocker adapted to block light rays, received from the first light emitting element and/or the second light emitting element, having angles of incidence within at least one selected angle interval.

12. The illumination device according to claim 11, wherein the light blocker comprises at least two light blocking units, wherein a first light blocking unit is adapted to block light rays within a first selected interval of angles of incidence and is arranged to block light received light from the first light emitting element, and wherein a second light blocking unit is adapted to block light rays within a second selected interval of angles of incidence and is arranged to block light received light from the second light emitting element.

13. The illumination device according to claim 11, wherein the light blocker is adapted to vary the interval of angles of incidence that is blocked by the light blocker, such that the interval of angles of incidence of the light rays impinging on the light in-coupling surface varies with respect to the position of incidence of the light on the in-coupling surface.

14. A luminaire comprising an illumination device according to claim 1.
